(19) United States
(12) Patent Application Publication
(10) Pub. No.: US 2018/0110232 A1
(43) Pub. Date: Apr. 26, 2018

(54) DOUGHNUT DOUGH SHAPING MACHINE

(71) Applicant: Ju Hui KANG, Gyeonggi-do (KR)

(72) Inventor: Ju Hui KANG, Gyeonggi-do (KR)

(21) Appl. No.: 15/561,883

(22) PCT Filed: Mar. 24, 2016
(86) PCT No.: PCT/KR2016/003010

§ 371 Date: Sep. 26, 2017

(30) Foreign Application Priority Data
Mar. 27, 2015 (KR) 10-2015-0043501

(51) Int. Cl. A21C 11/00; A21C 3/10

(52) U.S. Cl. CPC A21C 11/002; A21C 3/10

(57) ABSTRACT

A doughnut dough shaping machine, has a plurality of shaping bodies, which constitute a shaping part, arranged at predetermined gaps and coupled between two disc-type shaping support parts; has a cylinder rod-shaped operating part, which comprises a coupling part and a handle part, provided at through-parts perforated at the center of each shaping support part by means of bearing parts, so as to roll the shaping support parts and the shaping part on the upper surface of the doughnut dough, thereby making a uniform doughnut; and cuts only both end sections of the doughnut dough by non-cut shaping parts at the centers of the shaping bodies and cut-shaping parts at both ends thereof, such that the cut doughnut dough is overlapped in a cylinder shape, thereby producing a flower-shaped doughnut.

### BACKGROUND

The present invention relates to a doughnut dough shaping machine, and more particularly, to a doughnut dough shaping machine which may shape a doughnut in the same shape and the same weight by transferring a rotational force and a pressure of the doughnut dough shaping machine to doughnut dough when a large amount of doughnuts are produced, making it possible to rapidly and hygienically produce a uniformed doughnut.

A doughnut is a bread made by twisting dough formed by putting sugar, eggs, milk, fat, and yeast in flour or shaping the dough in a ring shape, and then frying the dough in oil. In U.S. in nineteenth century, a bread made by putting nuts in a central portion thereof by Dutch immigrants is the beginning of the doughnut. Further, the doughnut is widely used as a snack as well as a breakfast menu.

The doughnut is classified into a doughnut in which yeast is put and which is fermented and a doughnut in which a chemical leavening agent such as baking powder is put. Because carbon dioxide in dough, which is generated through fermentation, inflates the doughnut in which yeast is put while the doughnut is fried in oil, a food texture of the doughnut is soft. Further, the doughnut in which a chemical leavening agent is put is relatively strong, and because sugar or eggs are put in the doughnut, the doughnut tastes like a cake.

There is a problem in that because the doughnut passes through various steps such as kneading, fermenting, shaping, heating, and post-processing during production, when a large amount of doughnuts are manually produced for sales, a long time is consumed, and thus, workability is degraded, and the shapes and the weights of the doughnuts are ununiform. Further, because all processes are performed by manpower, hygiene is degraded.

To solve the above problem, a doughnut dough shaping machine which may produce a large amount of doughnut dough through shaping bodies attached to an end thereof, by inserting dough into a dough supply hopper and operating a piston using a pressure generated inside the hopper, is disclosed in Korean Patent Application Publication No. 10-2007-0041328 entitled “A ring-type and circle-type automatic doughnut shaping machine”.

However, the conventional invention has a problem in that the shape of a shapeable doughnut is limited to a ring and a circle, reshaping of the shape after the shaping is completed is not easy, and a large space and high costs for installing equipment are consumed.

To solve the above problem, the present invention provides a doughnut dough shaping machine which may rapidly and efficiently produce a doughnut having a uniform shape and a uniform weight, may freely reshape the doughnut as needed even after dough is shaped, may reduce costs for use, storage, and installation due to a small size thereof, and may provide a hygienic production environment.

### SUMMARY OF THE INVENTION

The present invention relates to a doughnut dough shaping machine.

An aspect of the present invention is to provide a doughnut dough shaping machine which may rapidly and efficiently produce a product having a uniform shape and a uniform weight when a large number of doughnuts having the same shape and the same weight are produced.

Further, another aspect of the present invention is to provide a doughnut dough shaping machine which may secure corrosion resistance against corrosion generated due to characteristics of a manual tool.

To achieve the above-described aspects, the present invention provides a doughnut dough shaping machine in which a plurality of shaping bodies constituting a shaping part are arranged at a specific interval and are coupled between two disc-type shaping support parts such that doughnut dough may be shaped in the same shape, and a cylindrical rod manipulation unit including a binding part and handle parts is installed in a penetration part perforated at the center of each shaping support part by medium of a bearing unit, so that a uniformed doughnut may be produced by rolling the shaping support part and the shaping part on the upper surface of the doughnut dough. Further, the present invention provides a doughnut dough shaping machine in which a plurality of air outlets are formed in the shaping support parts to, when the doughnut dough is processed, discharge compressed air between the doughnut dough and the shaping bodies, so that the doughnut dough is easily separated from the shaping bodies.

Further, the present invention provides a doughnut dough shaping machine in which each of components constituting the doughnut dough shaping machine is made of stainless steel, so that corrosion resistance against corrosion generated due to characteristics of a manual tool that is in contact with water during washing or using is secured.

The present invention relates to a doughnut dough shaping machine which may efficiently produce a doughnut having a uniform shape and a uniform weight when a large amount of doughnuts are produced, and maximizes efficiency in producing a doughnut having a uniform shape and a uniform weight by using a handle part on which a hand of a worker may be held to apply a rotational force and a pressure and a shaping part including a plurality of shaping bodies which may shape doughnut dough by applying the rotational force and the pressure transferred from the handle part to the upper surface of the doughnut dough.

Further, according to the present invention, a plurality of air outlets are installed in shaping support parts to, when the doughnut dough is shaped, discharge compressed air between the shaping bodies and the doughnut dough, so that the shaped dough is easily separated from the shaping bodies, thereby improving work efficiency.

### BRIEF DESCRIPTION OF THE DRAWINGS

FIG. 1 is a view illustrating implementation of a doughnut dough shaping machine.

FIG. 2 is a sectional view illustrating the doughnut dough shaping machine.

FIG. 3 is an exploded perspective view illustrating the doughnut dough shaping machine.

FIG. 4 illustrates a flower-shaped doughnut produced by using the doughnut dough shaping machine.

### DETAILED DESCRIPTION OF THE INVENTION

Hereinafter, the present invention will be described in more detail with reference to the accompanying drawings.

The present invention relates to a doughnut dough shaping machine which rapidly produces a doughnut having a uniform shape and a uniform weight when a large amount of doughnuts are produced, and provides a doughnut dough shaping machine including: a cylindrical rod manipulation unit 10 including a binding part 12 and handle parts 11; a pair of disc-type shaping support parts 30 in which penetration parts 31 are perforated such that the manipulation unit 10 passes therethrough; and a shaping part 20 formed by coupling a plurality of shaping bodies 21 between the pair of shaping support parts 30, wherein a uniformed doughnut may be produced by rolling the shaping part 20 fixed and coupled between the shaping support parts 30 on the upper surface of doughnut dough.

The present invention provides a doughnut dough shaping machine in which the cylindrical rod manipulation unit 10 is installed by medium of a bearing unit 40 so that a uniformed doughnut may be produced by rolling the shaping support parts 30 and the shaping part 20 on the upper surface of doughnut dough 50.

In more detail, the cylindrical rod manipulation unit 10 includes the opposite handle parts 11 and the binding part 12 between the handle parts 11, and the manipulation unit 10 passes through the penetration parts 31 of the pair of disc-type shaping support parts 30 and is installed by medium of the bearing unit 40. The shaping part 20 is formed by fixing and coupling the plurality of shaping bodies to the pair of shaping support parts, and the uniformed doughnut may be produced by rolling the shaping part and the shaping support parts on the upper surface of the doughnut dough.

That is, the manipulation unit 10 is formed to have a long cylindrical shape such that a hand of a user is held thereon to make it easy to apply a rotational force and a pressure, and the doughnut dough 50 may be shaped by applying a rotational force and a pressure to the handle parts 11 at opposite ends of the manipulation unit 10, and transferring the rotational force and the pressure to the shaping bodies 21.

Further, rings 13 are formed on surfaces of the handle parts 11, and thus, when the doughnut dough shaping machine is not used, the doughnut dough shaping machine may be efficiently stored by hanging the rings 13.

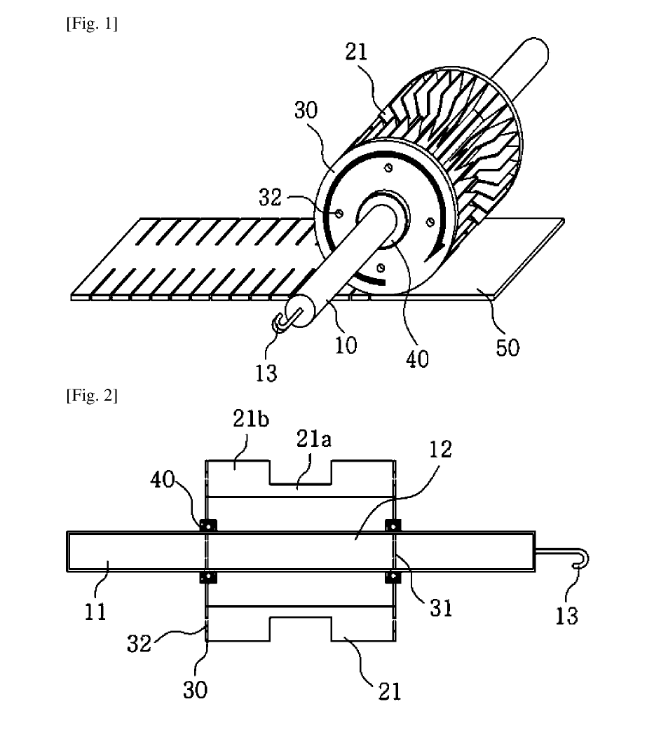

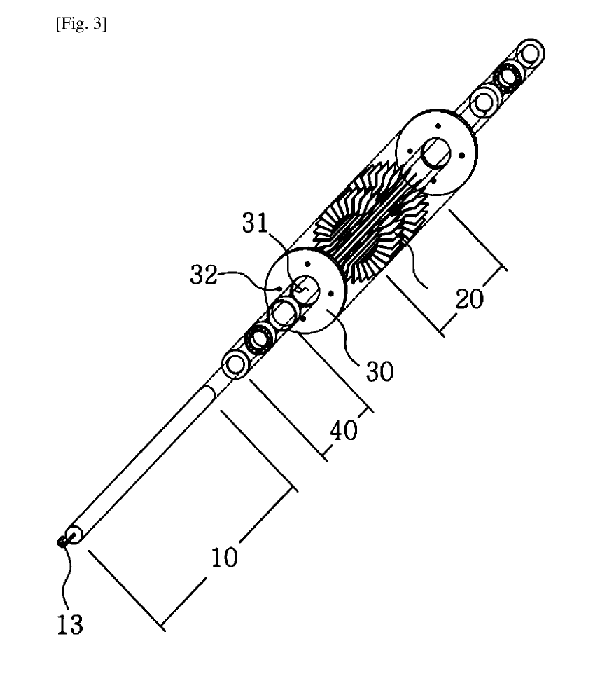

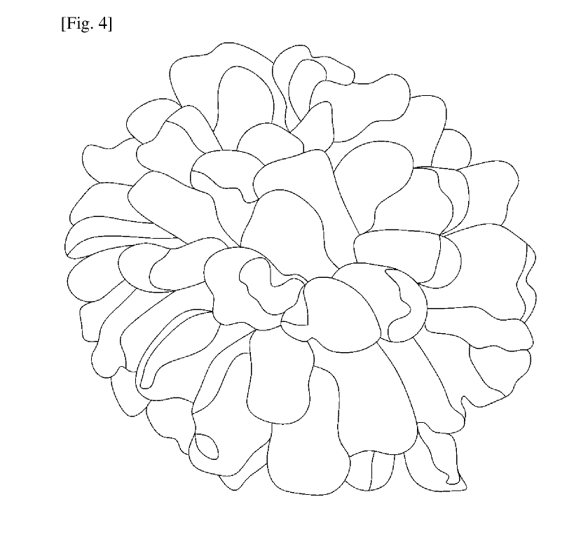

The shaping bodies 21, each having a non-cut shaping surface 21a at the center thereof, and cut shaping surfaces 21b at opposite ends thereof, are arranged in the shaping unit 20. Thus, as illustrated in FIG. 1, the rotational force and the pressure applied to the handle parts 11 are transferred to the shaping bodies 21, and thus, are applied to the doughnut dough 50. Therefore, the doughnut dough 50 is shaped at a uniform interval, so that efficiency in producing a large amount of doughnuts may be improved. Further, a central portion of the doughnut dough is not cut due to the non-cut shaping surface at the center of each shaping body, and opposite ends of the doughnut dough may be cut by the cut shaping surfaces at the opposite ends of the shaping body, so that a flower-shaped doughnut as illustrated in FIG. 5 may be produced by allowing the cut doughnut dough to cylindrically overlap each other.

The shaping bodies 21 arranged at a specific interval are coupled to surfaces of the shaping support parts 30, the shaping support parts 30 are formed in a disc-type shape such that the rotational force applied to the manipulation unit 10 is easily transferred to the shaping part 20, and the shaping support parts 30 have the penetration parts 31 at the center thereof such that the binding part 12 of the handle parts 10 may pass through and be fastened to the penetration parts 31. Further, a plurality of air outlets 32 are formed at a space between the shaping bodies 21, and thus, when the rotational force and the pressure applied to the manipulation unit 11 are transferred to the shaping bodies 21 and are thus applied to the upper surface of the doughnut dough 50, the air outlets 32 discharge compressed air between the shaping bodies 21 and the doughnut dough 50, so that the shaped doughnut dough 50 may be easily separated from the shaping bodies 21.

The bearing unit 40 is installed between the penetration parts 31 of each shaping support part, and when the handle parts 11 are rotated, rotates the shaping part 20 fastened to one surface of the shaping support part 30 through the rotation of the handle parts 11, while supporting a self-weight of the handle parts 11 and a load applied to the handle parts 11.

Because the doughnut dough shaping machine is in contact with water during washing or using, and thus, risks to be corroded, each component of the doughnut dough shaping machine is made of stainless steel, so that the doughnut dough shaping machine may resist corrosion.

Because it is apparent that functions of components of the bearing unit 40 may be inferred from the widely-known bearing-related technology, the functions are not separately described.

Description of Reference Numerals

| | |
|---|---|
| 10. Manipulation unit | 11. Handle parts |
| 12. Binding part | 13. Rings |
| 20. Shaping part | 21. Shaping bodies |
| 21a. Non-cut shaping surface | |
| 21b. Cut shaping surfaces | |
| 30. Shaping support parts | |
| 31. Penetration parts | 32. Air outlets |
| 40. Bearing unit | 50. Doughnut dough |

1. A doughnut dough shaping machine for rapidly producing a doughnut having a uniform shape and a uniform weight when a large amount of doughnuts are produced, the doughnut dough shaping machine comprising:
a cylindrical rod manipulation unit comprising a binding part and handle parts;
a pair of disc-type shaping support parts (30) in which penetration parts are perforated such that the manipulation unit passes therethrough;
a shaping part formed by fixing and coupling a plurality of shaping bodies between the pair of shaping support parts,
wherein a uniformed doughnut is produced by rolling the shaping part fixed and coupled between the shaping support parts on an upper surface of doughnut dough

2. The doughnut dough shaping machine of claim 1, wherein each of the shaping bodies comprises cut shaping parts at opposite ends thereof, and a non-cut shaping part at a center thereof, so that a flower-shaped doughnut is produced by cutting opposite ends of the doughnut dough and allowing the cut doughnut dough to cylindrically overlap each other.

3. The doughnut dough shaping machine of claim 1, further comprising rings coupled to surfaces of the handle parts.

4. The doughnut dough shaping machine of claim 1, further comprising air outlets (32) perforated in the shaping support parts,
wherein when a rotational force and a pressure applied to the manipulation unit are transferred to the shaping bodies and are applied to an upper surface of the doughnut dough, compressed air is discharged between the shaping bodies and the doughnut dough, so that the shaped doughnut dough is easily separated from the shaping bodies.
